(19) United States
(12) Patent Application Publication
(10) Pub. No.: US 2021/0281678 A1
(43) Pub. Date: Sep. 9, 2021

(54) METHOD AND SYSTEM FOR SCREENING VOICE CALLS

(71) Applicant: Advanced Messaging Technologies, Inc., Los Angeles, CA (US)

(72) Inventors: Alan M. Vale, Palo Alto, CA (US); Robert Newman, Lake Forest, IL (US); Anton Makarenko, Moycullen Co. Galway (IE)

(21) Appl. No.: 16/811,914

(22) Filed: Mar. 6, 2020

(51) Int. Cl. H04M 3/436; H04M 3/38; H04M 3/42; H04M 3/523; H04M 3/51; G06F 21/32; G10L 15/26

(52) U.S. Cl. CPC H04M 3/436; H04M 3/385; H04M 3/42382; H04M 3/5235; H04M 2203/6072; G06F 21/32; G10L 15/265; H04M 2203/158; H04M 2203/2066; H04M 3/5191

(57) ABSTRACT

Methods and apparatus are described for a telephony server screening voice calls. In one embodiment, the telephony server receives, form an originating device, an incoming call to be routed to a receiving device. The server answers the incoming call to establish a communication link with the originating device. The server transmits, via the communication link, a challenge audio signal containing an audio message for playback by the originating device. The server receives, via the communication link, a response from the originating device, and, in response to authenticating the response, routes the incoming call to the receiving device. Other embodiments are also described and claimed.

### FIELD

An embodiment of the disclosure is related to a telephony system that screens an incoming voice call from an originating device before routing the call to a receiving device. Other embodiments are also described.

### BACKGROUND

In recent years, with the proliferation of mobile phones has come a growth of unsolicited phone calls. The most complained of which are spam calls or robocalls in which a computerized autodialer calls a user and delivers a pre-recorded message when the call is answered. Some of these calls may be deployed by legitimate telemarking companies that are soliciting prospective customers to buy products or services. Many, however, are fraudsters who bombard users at all hours to lure them into scams (e.g., when a caller claims to be collecting money owed to the Internal Revenue Service) or to steal a person's identity or financial information.

### SUMMARY

To combat the onslaught of unsolicited spam calls, users who have received calls may register the incoming telephone number of the calls with the National Do Not Call Registry. This may involve, however, first answering the phone call to determine that the caller is a computerized dialer. Another way is to manually screen calls, in which a person may physically evaluate characteristics of a telephone call before deciding to answer the call. For instance, upon receiving the call, the person's telephone may display (e.g., on a display screen) caller ID information, such as a telephone number of the incoming call. From the caller ID information, the person may decide to pick up the call or allow the call to go to a messaging service (e.g., voicemail). In addition, some telephone service providers (carriers) and third-party companies may offer a spam call filtering service, which when used by a customer may alert the customer when a call is likely spam. Each of these methods, however, has drawbacks. For example, to manually screen calls, a user is required to divert attention to the unsolicited phone call, which may be annoying. With the spam call filtering service, spam calls may be filtered based on customer feedback (e.g., customers reporting phone numbers of spammers) from the entire customer base of the carrier and/or of other service providers. Thus, a person may not have any control as to which calls are filtered. In addition, each of the methods may not decrease the volume of spam calls due to spoofing, in which a number shows up differently on caller ID. As a result, spam calls may appear differently on caller ID every time a call is made. Therefore, there is a need for a voice call screening service that may be personalized for a specific person in order to effectively reduce the volume of unsolicited phone calls.

The instant disclosure is directed to a method performed by a telephony system of a voice calling service, such as j2 Cloud Services, Inc. of Hollywood, Calif., to automatically screen voice calls that are directed to subscribers. For instance, the service assigns each subscriber a direct inward dialing (DID) telephone number, which is associated with the subscribers receiving device (e.g., a landline telephone). The subscriber may distribute the DID telephone number to those who the subscriber wishes to call them. An incoming call made to the subscriber is first directed to (e.g., a server) of the telephony system. The system may answer the incoming call to establish a communication link with the caller's originating device. The system may transmit a challenge audio signal containing an audio message for playback by the originating device, where the audio message is a verbal question or a verbal command. Specifically, the challenge audio signal may contain a subscriber defined question or command, of which only those persons who the subscriber wishes to receive phone calls from would know the answer or correct response. For example, the verbal question may include “What is the code?” or “What is my favorite color?”, which may not be known by a computerized autodialer. The system receives a response from the originating device, and upon authenticating the response, routes the incoming call to the receiving device. In particular, the system may compare the response to a predefined response to the question or command, and may route the incoming call when both responses match (e.g., to the question of the favorite color, the response may be “red”). If, however, the response is not authenticated (e.g., rather than the response being “red” the response received is “green” or rather no response is received at all), the system may disconnect the call.

Therefore, the method is a voice call screening service that screens inbound calls from computerized autodialers and unwanted callers from being connected with the intended party. Furthermore, the method provides subscribers with a personalized voice call screening feature so as to further control the volume of inbound calls that are routed to a subscriber.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the disclosure are illustrated by way of example and not by way of limitation in the figures of the accompanying drawings in which like references indicate similar elements. It should be noted that references to “an” or “one” embodiment of the disclosure in this disclosure are not necessarily to the same embodiment, and they mean at least one. Also, a given figure may be used to illustrate the features of more than one embodiment of the disclosure, and not all elements in the figure may be required for a given embodiment.

FIG. 1 is a block diagram illustrating a telephony system, according to some embodiments.

FIG. 2 shows a block diagram illustrating a telephony server, according to some embodiments.

FIG. 3 is a flowchart of one embodiment of a process to set up a challenge and response for voice call screening, according to some embodiments.

FIG. 4 is a flowchart of one embodiment of a process performed by a telephony system to screen an incoming voice call, according to some embodiments.

FIG. 5 is a flowchart of one embodiment of a process to determine whether an incoming call should be challenged, according to some embodiments.

### DETAILED DESCRIPTION

Several embodiments of the disclosure with reference to the appended drawings are now explained. Whenever aspects of the embodiments described here are not explicitly defined, the scope of the disclosure is not limited only to the parts shown, which are meant merely for the purpose of illustration. Also, while numerous details are set forth, it is understood that some embodiments of the disclosure may be practiced without these details. In other instances, well-known circuits, structures, and techniques have not been shown in detail so as not to obscure the understanding of this description.

References in the specification to “one embodiment” or “an embodiment” means that a particular feature, structure, or characteristic described in conjunction with the embodiment can be included in at least one embodiment, but every embodiment may not necessarily include the particular feature, structure, or characteristic. Moreover, such phrases are not necessarily referring to the same embodiment.

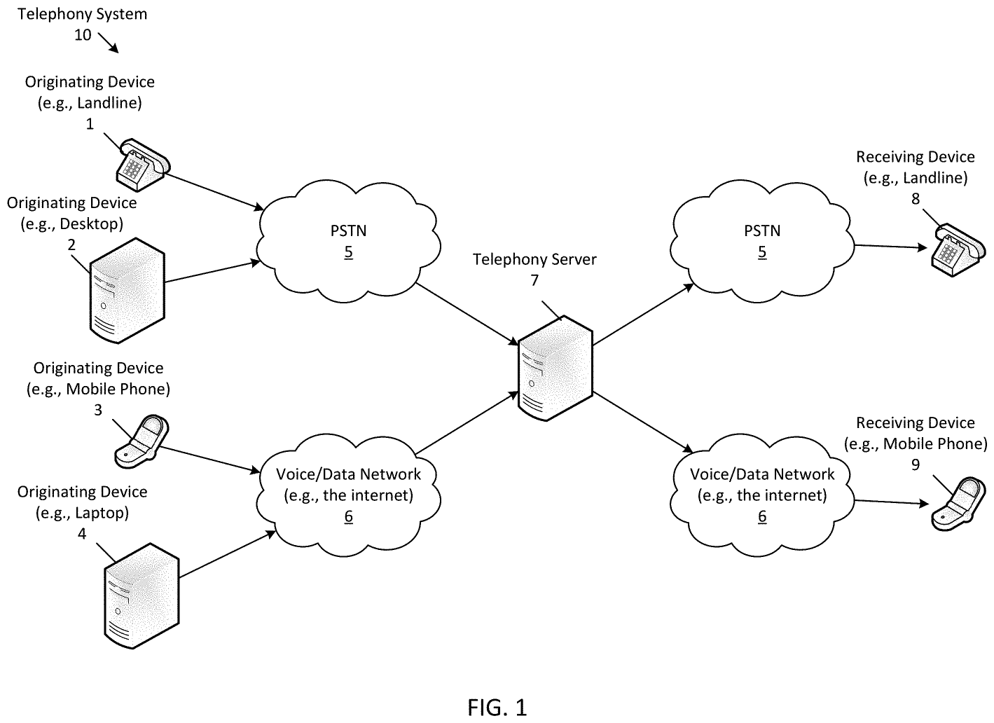

FIG. 1 is a block diagram illustrating a telephony system 10, according to some embodiments. The telephony system 10 includes four originating devices 1-4, a public switched telephone network (PSTN) 5, a voice/data network (e.g., the internet) 6, one or more telephony servers 7, and two receiving devices 8 and 9. In one embodiment, the system may include more or less devices. As illustrated, originating device 1 (e.g., a landline telephone) and originating device 2 (e.g., a desktop computer) are coupled to the telephony server 7 via the PSTN, and originating device 3 (e.g., mobile phone or smart phone) and originating device 4 (e.g., laptop) are coupled to the telephony server via the network. In addition, receiving device 8 (e.g., landline telephone) is coupled to the telephony server 7 via the PSTN, and receiving device 9 (e.g., mobile phone) is coupled to the server via the network. In one embodiment, one or more of the devices may be coupled to the telephony server via one or more networks. For instance, originating device 2 may be arranged to couple to the telephony server via the PSTN and/or the voice/data network 6.

The originating device 1 and 2 may be any electronic devices that are capable of placing outgoing calls and/or receiving incoming calls over the PSTN 5 to and from 1) one or more of the receiving devices 8 and 9 and/or 2) the telephony server 7. For instance, originating device 1 may be any type of telephone (e.g., touch-tone telephone) that utilizes Dual-Tone Multi-Frequency (DTMF) signaling to make an outgoing phone call via the PSTN. As illustrated, originating device 2 is a desktop computer. This device, however, may be any device (e.g., laptop, etc.) that includes a dial-up modem and telephony software, which when executed may use the dial-up modem to place outgoing calls (by establishing a dial-up connection) via the PSTN.

The originating device 3 and 4 may be any electronic devices that are capable of placing outgoing calls and/or receiving incoming calls over the voice/data network 6 (e.g., the internet) to and from 1) one or more of the receiving devices 8 and 9 and/or 2) the telephony server 7. For instance, as illustrated, device 3 is a mobile phone. In some embodiments, this device may be any portable device, such as a tablet computer or a smart phone. Similarly, the receiving devices 8 and 9 may be any electronic devices that are capable of receiving incoming calls (and/or placing outgoing calls). For instance, receiving device 9 may be any mobile device that is capable of receiving phone calls originating from the PSTN 5, the voice/data network 6, or similar communication networks, e.g., a mobile phone, a smart phone, a tablet, or a laptop. For example, the mobile phone 9 may receive an incoming call originated by the device 1 through the PSTN 5, which may then route the call to a mobile switching center (e.g., which may be a part of the voice/data network 6) that connects the call with the mobile phone 9, via a cell tower).

In one embodiment, the voice/data network 6 may include infrastructure that enables one or more devices to receive and make the calls. For instance, the network may include one or more cell towers (not shown), all of which may be a part of a communications network that supports voice calls for mobile devices (e.g., a 4G Long Term Evolution (LTE) network). In some embodiments, the network 6 may include one or more (wired or wireless) routers, all of which may be a part of other communication networks that supports voice-over-IP (VoIP) between the originating devices and other devices (e.g., local area networks and wireless area networks).

The telephony server 7 is capable of processing incoming voice calls destined to subscribers of a voice calling service. As described herein, subscribers are each assigned a direct inward dialing (DID) telephone number, which is associated with the subscriber's receiving device (e.g., a landline telephone). In one embodiment, the DID telephone number may be different than a personal telephone number (e.g., a conventional telephone number, a VoIP phone number, etc.) assigned to the subscriber's device by the subscriber's telephone service provider. Thus, the server 7 may associate the DID telephone number with the subscriber's personal telephone number (e.g., by storing them in local memory). When a person calls the subscriber's DID telephone number, the call is received by the telephony server 7, which may perform one of several operations or services. For example, the server may be capable of routing incoming calls from originating devices to intended subscribers (or more specifically (receiving) devices of the subscribers). For instance, upon receiving an incoming call the server 7 may determine which DID telephone number the call is directed (e.g., based on caller ID information). The server 7 may determine which subscriber is assigned that DID telephone number, and whether the DID number is associated with a personal telephone number of the subscriber. Once determined, the server may route (e.g., call forward, conference, etc.) the incoming call to the subscriber's personal telephone number. As described herein, the telephony server 7 may also be capable of performing voice call screening operations upon incoming calls in order to screen (or filter) unwanted calls, such as robocalls. More about the operations performed by the telephony server are described herein.

As shown, the server 7 is a stand-alone server computer or a cluster of server computers that may implement the telephony server 7. In one embodiment, the server may be part of a cloud computing system that is capable of operating the voice calling service as a cloud-based service.

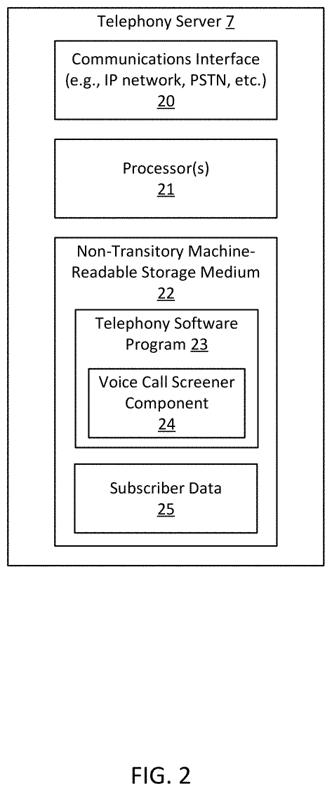

FIG. 2 shows a block diagram illustrating the telephony server 7, according to some embodiments. The server includes a communications interface 20, one or more processor(s) 21, and a non-transitory machine-readable storage medium 22. Examples of non-transitory machine-readable storage medium may include read-only memory, random-access memory, CD-ROMS, DVDs, magnetic tape, optical data storage devices, flash memory devices, and phase change memory. As illustrated, the non-transitory machine-readable storage medium has stored therein a telephony software program 23 and subscriber data 25. The telephony software program includes a voice call screener component 24, which when executed by the processors 21 performs voice call screening service operations, as described herein.

In one embodiment, the subscriber data 25 may include information of subscribers of the voice call service and the voice call screening service. Specifically, the data may be in the form of a data structure that includes a lookup table having subscriber information, such as the subscriber's name, the subscriber's personal telephone number (which is associated with a receiving device of the subscriber), the subscriber's assigned DID telephone number, etc. In some embodiments, the data may include subscriber settings or parameters, such as whether or not a subscriber authorizes (or has activated) the telephony server to perform call screening, as described herein.

The communications interface 20 provides an interface for the telephony server 7 to receive a call from an originating device (e.g., device 1) over a voice communications network (e.g., the PSTN 5 or the voice/data network 6) in order to establish a communication link in which a downlink signal is received and an uplink signal is transmitted in order to exchange data. In one embodiment, the communications interface 20 also provides an interface for the server to exchange data with the receiving devices and/or to route calls from the originating device.

The processor 21 may include one or more data processing circuits, generically referred to herein as “a processor.” The processor may execute the telephony software program 23 to perform some or all of the voice calling service operations and methods that are described herein, for one or more of the embodiments related to the server 7. For example, the processor 21 may execute the telephony software program 23 to receive a call from an originating device to be routed to a receiving device, identify a telephone number of the receiving device, and determine whether the receiving device is associated with an existing subscriber of the voice calling service based on the identified telephone number. For instance, upon receiving the incoming call, the program may identify the telephone number of a receiving device of which the originating device is calling (e.g., from caller ID information). The program may perform a table lookup into the subscriber data 25 to determine whether telephone number is a DID telephone number that is assigned to an existing subscriber. If so, the telephony software program 23 may route the incoming call to the receiving device, as described herein. For example, the program may forward the call to the subscriber's receiving device (e.g., by routing the call to the subscriber's personal phone number). As another example, the program may conference the incoming call with an outgoing call that is placed by the telephony server 7 to the subscriber's receiving device. In this case, the program may answer (pick up) the incoming call, place the outgoing call to the subscriber's receiving device, and then conference both calls together.

In some embodiments, the processor 21 may execute the voice call screener component 24 of the software program 23 to perform voice call screening service operations in order to screen (or filter) unwanted calls, such as robocalls, as described herein. Specifically, the component may receive, from an originating device (e.g., landline 1 via the PSTN 5), an incoming call to be routed to a receiving device (e.g., landline 8). The component may answer the incoming call to establish a communication link with the originating device (e.g., to receive a downlink communications signal from the originating device and transmit an uplink communications signal to the originating device). The component transmits, via the communication link, a challenge audio signal containing an audio message for playback by the originating device. The component receives a response from the originating device, and in response to authenticating the response, routes the incoming call to the receiving device. If, however, the response is not authenticated the call may be disconnected. More about voice call screening operations performed by the (component 24 of the) telephony server 7 is described herein.

In another embodiment, the subscriber data 25 may include data regarding which incoming calls are to be challenged when a voice call screening service is activated, as described herein. For instance, the data may be subscriber defined, such as a blacklist that indicates which specific phone numbers associated with incoming calls are to be challenged. In one embodiment, the subscriber may manually enter contact information of specific telephone numbers associated with inbound callers who should be challenged. As another example, the subscriber may define a group of people that are to be challenged, such as callers from the same area code. As another example, the data may have a whitelist that indicates which calls are not to be challenged. Similar to the blacklist, the subscriber may define specific numbers or a group of numbers that are not to be challenged (e.g., numbers from a different area code than defined in the blacklist). In some embodiments, such a whitelist may be automatically (e.g., without user intervention) be defined by the server. In one embodiment, either the blacklist or the whitelist may include at least some contact information contained within a contacts list of the subscriber. For instance, the whitelist may contain all the contact information within the contacts list. In another embodiment, contact information may be obtained from other lists, such as an address book or a VIP list. In one embodiment, callers whose information is not contained within the whitelist may automatically be challenged.

In another embodiment, the subscriber data 25 may include subscriber-specific call analytics. Specifically, the data may indicate information regarding phone numbers of calls made to or from the subscriber's device. For instance, the data may indicate incoming phone numbers of previous incoming calls that have been answered (e.g., picked up) by the subscriber within a past period of time (e.g., within the past ninety days). Since the subscriber has answered previous incoming calls it may be assumed that the subscriber knows the caller. In addition, the data may indicate phone numbers to which the subscriber has placed a previous outgoing call to within a past period of time. In another example, the data may indicate phone numbers of previous incoming calls with which the subscriber has answered and also remained on the line (e.g., did not hang up) until after a period of time (e.g., over one minute). In another embodiment, the data may indicate which phone numbers of previous incoming calls have been challenged since a previous period of time.

In some embodiments, the subscriber data 25 may be automatically and dynamically updated. For instance, phone numbers that are contained within the whitelist may be removed from the list after a period of time (e.g., within ninety days). In another embodiment, callers that are challenged and who provide an authorized response may be added to the whitelist. In one embodiment, once numbers are added to the whitelist, they may remain in the list permanently or may be added temporarily, as described herein. In some embodiments, the stored analytics may change as well over time. In another embodiment, after a period of time, phone numbers may be removed or deleted from the subscriber data entirely.

In some embodiments, the subscriber data 25 may include additional data, such as audio data of a challenge that contains an audio message of a verbal question or verbal command that may be transmitted to an originating device in order to screen the originating device. This data may also include audio data of a predefined response that is used to determine whether a challenge is authenticated by the originating device. In one embodiment, this data may be subscriber-defined or may be default data that may be accessible to one or more subscribers. More about the challenge and the response are described herein.

In some embodiments, the telephony software program 23 may include one or more other components or algorithms, which when executed by the processor 21 perform other operations. For example, the program may include a text-to-speech (TTS) component, which when executed converts text to an audio signal that is a phonemic representation of the text. As another example, the program may include a speech recognition component (e.g., having a voice-to-text algorithm), which when executed by the processor 21 converts speech content contained within an audio signal into text. More about these components is described herein. In one embodiment, the telephony software program 23 may include an auto-attendant component, which when executed is capable of conducting a conversation with a person over a telephone call in order to perform one or more operations, as described herein.

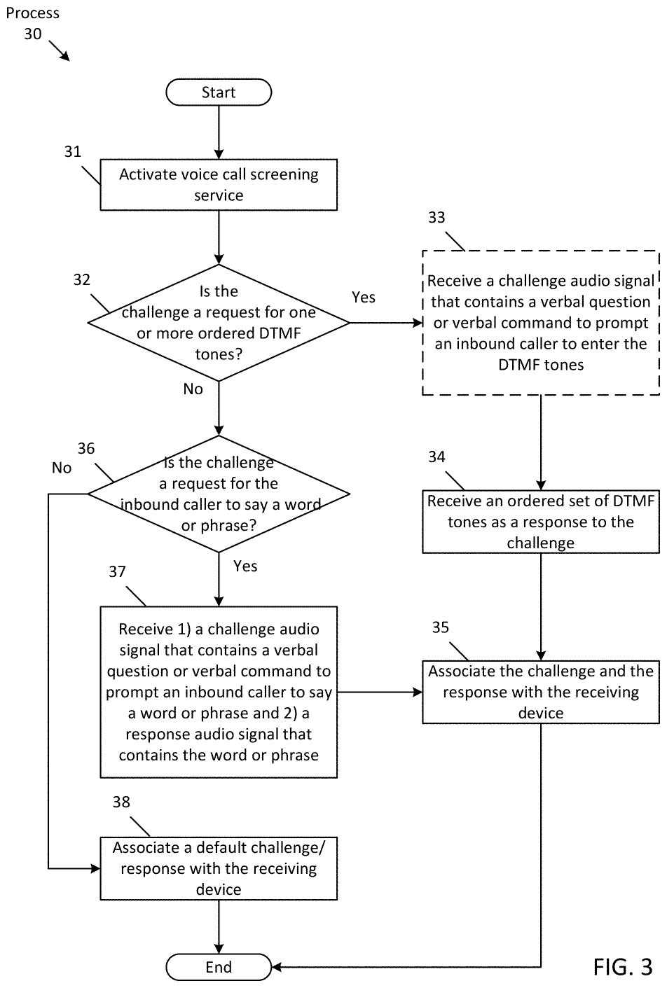

FIG. 3 is a flowchart of one embodiment of a process 30 to set up a challenge and a response to the challenge for voice call screening according to some embodiments. Specifically, this process allows a subscriber to predefine a challenge and/or a response to the challenge, which may be used to authenticate a future inbound caller. This process may be performed by the (e.g., telephony software program 23 of the telephony server 7 of the) telephony system 10 of FIG. 1. In one embodiment, at least some of the operations may be performed by at least one receiving device, as described herein. For example, at least some of the operations may be performed while the subscriber is conducting (via a receiving device of the subscriber, such as mobile phone 9 of FIG. 1) an auto-attendant phone call with the telephony server 7 in order to set up the voice call screening service. Specifically, the subscriber may call a dedicated customer support line and follow verbal prompts given by an auto-attendant to set up the voice call screening service.

The process 30 begins by activating the voice call screening service (at block 31). For instance, the telephony server 7 may receive a request from the subscriber to activate the service via a prompt during the auto-attendant phone call. For instance, the prompt may be a verbal command by the subscriber (e.g., “Activate Call Screening”), or a selection of a key from a keypad. In the case of a key selection, a selection may cause a DTMF tone to be transmitted as an audio signal to the server 7, which uses the tone to determine the user-selection. In one embodiment, the voice call screening service is deactivated by default for subscribers of the voice calling service. Thus, in order to activate call screening, subscribers must “opt-in” by affirmatively activating the service, as described herein. In one embodiment, the voice call screening service is automatically activated, and subscribers must “opt-out”, or affirmatively disable the service (e.g., via a prompt within the auto-attendant phone call).

The process 30 determines whether the challenge is a request for an inbound caller to enter one or more ordered DTMF tones (at decision block 32). For instance, the auto-attendant may ask whether the subscriber wants the challenge to be a numbered code, where each number on a telephone keypad is associated a different DTMF tone. Thus, the subscriber may select a prompt during the phone call with the auto-attendant that indicates the challenge is to instruct an inbound caller to enter one or more keypad selections on the originating device. If so, the process 30 receives a challenge audio signal that contains a verbal question or verbal command to prompt an inbound caller to enter the one or more ordered DTMF tones (at block 33). Specifically, the subscriber may say the verbal question (e.g., “What is my favorite number?”) or verbal command (e.g., “Enter the secret code.”), and in response a microphone of the subscriber's receiving device may produce a microphone signal that contains the question or command. The subscriber's device may transmit, as an uplink signal, the microphone signal to the server, upon which the server performs a voice-to-text algorithm to produce a textual representation (e.g., text of a word or a phrase) of the speech contained therein. The process 30 receives an ordered set of DTMF tones as a response to the challenge (at block 34). In particular, the subscriber may press one or more keys on the keypad of the device with which the subscriber is conducting the phone call. Thus, the response may be DTMF tones associated with the numbers “2” and “3”. The process 30 associates the challenge and the response (being the ordered set of DTMF tones) with the subscriber's receiving device (at block 35). Specifically, the challenge and response are associated with the receiving device, such that future inbound callers may be screened by presenting the callers with the challenge, and comparing the caller's response to the subscriber's predefined associated response. The caller may be authenticated when the caller's response matches the associated response. More about challenging and authenticating callers are described herein. In one embodiment, the server associates the textual representation of the challenge and the ordered set of DTMF tones of the response by storing them in the subscriber data 25, and associating them with the subscriber's information (e.g., with the subscriber's DID telephone number). In one embodiment, the server may store the audio data, rather than (or in addition to) the textual representation. For instance, the server may store the challenge audio signal as a digital or analog signal.

If, however, the challenge is not a request for the inbound caller to enter one or more ordered DTMF tones, the process 30 determines if the challenge is a request for the inbound caller to say a word or phrase (at decision block 36). For instance, the subscriber may select a prompt during the phone call with the auto-attendant that indicates the challenge is to request a word or phrase. If so, the process 30 receives 1) a challenge as a (customized) challenge audio signal that contains a verbal question or verbal command to prompt an inbound caller to say a word or phrase and 2) a response as a response audio signal that contains the word or phrase (at block 37). For instance, the auto-attendant may instruct the subscriber to say the challenge (e.g., “What is my favorite color.”), and immediately thereafter instruct the subscriber to say the response (e.g., “Red.”). The server receives both signals as an uplink signal, as described herein. The process 30 associates the challenge and response with the receiving device (at block 35). For instance, as described above, the server may perform the voice-to-text algorithm upon both signals to produce a textual representation of the challenge and response. The server may store the textual representations in the subscriber data. In one embodiment, the server may store the audio signals in the data, as described herein.

If, however, the custom challenge is not to request for the inbound caller to say a word or phrase, the process 30 associates a default challenge and a response to the challenge with the receiving device (at block 38). In one embodiment, the default challenge may be a general verbal question or general verbal command (e.g., “Are you a robot?”). As described herein, such a challenge may prevent unwanted computerized autodialers from being routed to the subscriber's receiving device.

Some embodiments perform variations of the process 30. For example, the specific operations of the process 30 may not be performed in the exact order shown and described. The specific operations may not be performed in one continuous series of operations, some operations may be omitted, and different specific operations may be performed in different embodiments. For instance, as described herein, the operations may be performed while the subscriber conducts a phone call with an auto-attendant. In one embodiment, the operations may be performed while the subscriber conducts a phone call with a representative of the voice calling service. In another embodiment, the operations may be performed by a software program that is executed by one or more processors of an electronic device (e.g., the receiving device). For example, at least some of the determinations (e.g., whether the custom challenge is to request one or more DTMF tones) may be based on a user-selection of a GUI item in a menu displayed on the receiving device. As another example, the subscriber may navigate through prompts displayed within a website hosted by the (telephony server of the) voice calling service.

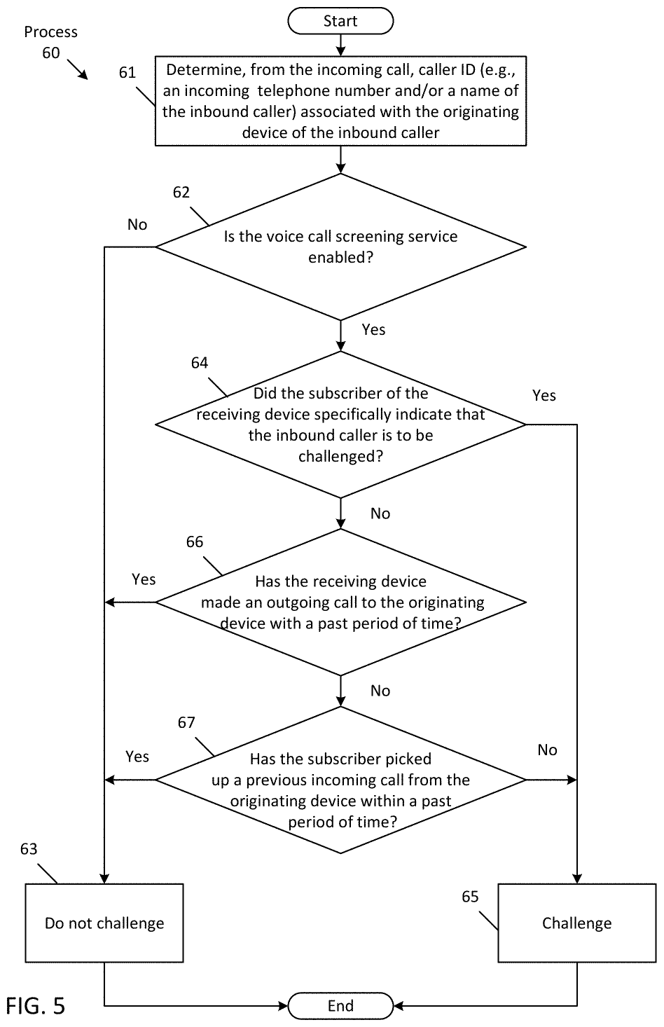

As described herein, the process 30 is for setting up a challenge and a response to the challenge for future inbound callers. In one embodiment, the challenge and the response may be used to authenticate inbound callers that meet at least some criteria for being challenged, for example as described in FIG. 5. Thus, the inbound callers that are to be challenged may each be presented the same challenge. In another embodiment, however, different inbound callers may be presented different challenges to induce the same or different responses. Specifically, the subscriber may perform the process 30 one or more times, each time setting up a different challenge and/or response. In addition, in one variation of block 35, the process 30 may assign the challenge and/or response to one or more inbound callers. For instance, a certain challenge may be assigned to one caller (e.g., a caller within the subscriber's contact list, such as “Mom”), where the challenge may be personal (e.g., “How many dogs have I had?”). In response, the inbound caller may select one or more keys on a keypad to transmit one or more associated DTMF tones as a response.

As another example, one or more challenges may be assigned to certain callers who satisfy thresholds within the call analytics of the subscriber data. For example, inbound callers who the subscriber has placed a call to may be associated with a first challenge and a first response, while inbound callers who have called the subscriber (within a past threshold of time) may be assigned with a second challenge and a second response. In some embodiments, the subscriber may define specific challenges and responses to specific inbound callers (e.g., based on caller information within the subscriber's contact list).

In one embodiment, the server 7 may receive input or prompts from the subscriber in several ways. For instance, as described herein, the subscriber may provide input by selecting a key from a keypad. In one embodiment, subscriber input may be through verbal commands. For example, at block 34 of the process 30, the server may receive a microphone signal, as an uplink signal, that contains the one or more ordered set of numbers (e.g., “One. Four. Seven. Seven.”), rather than (or in addition to) DTMF tons.

In one embodiment, at least some of the operations described herein are operational operations that may or may not be performed. Specifically, blocks that are illustrated as having dashed or dotted boundaries may optionally be performed. For example, the operations performed at block 33 may be optional. In this case, the challenge may be a default challenge (stored in memory of the server 7), which asks for an ordered set of numbers (e.g., “What is the four-digit code?”). In another aspect, other operations described in relation to other blocks may be optional as well.

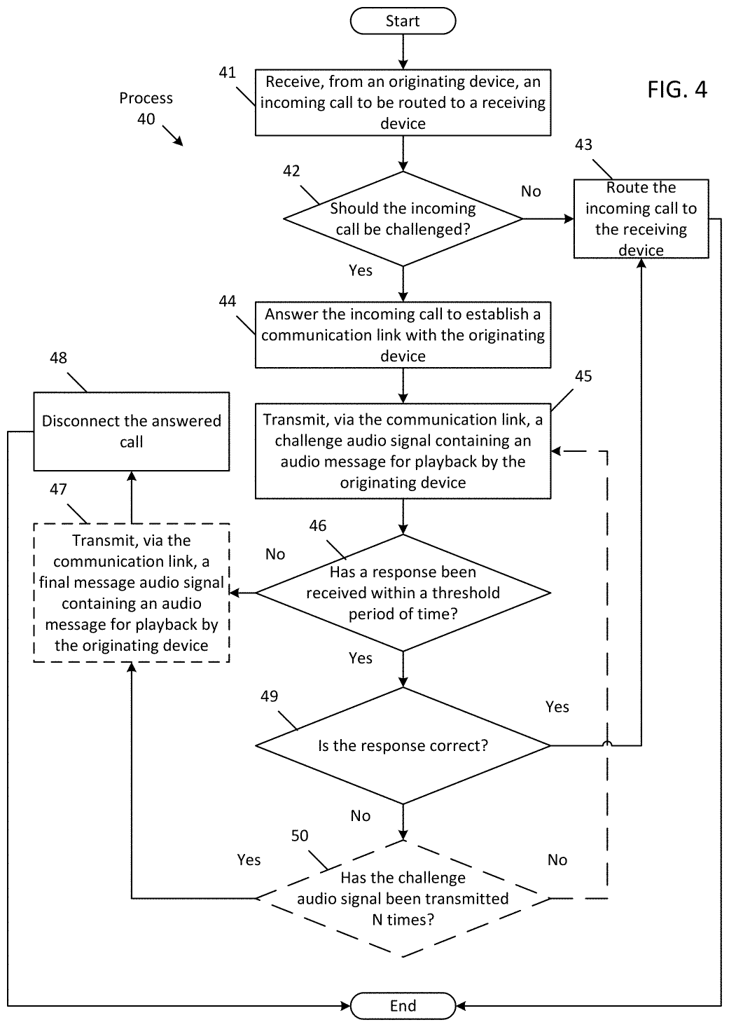

FIG. 4 is a flowchart of one embodiment of a process 40 performed by a telephony system (e.g., system 10 of FIG. 1) to screen an incoming voice call, according to some embodiments. In particular, the operations of the flowchart may be performed by the telephony software program 23 of the telephony server 7 (which is stored in memory of the telephony server, and executed by a processor of the server), as described in FIGS. 1-3. In one embodiment, at least some of the operations described with respect to process 40 may be performed after at least some of the operations of process 30 of FIG. 3. Specifically, prior to receiving an incoming call that is to be screened, the subscriber may have defined the challenge and response to the challenge.

In FIG. 4, process 40 begins when the telephony software program receives, from an originating device (e.g., device 1), an incoming call to be routed to a receiving device, such as device 8 (at block 41). For instance, the software program may identify that the communications interface 20 of the server 7 is receiving a control signal (e.g., from the PSTN 5), indicating that an incoming call has been made to the server. In one embodiment, along with identifying that an incoming call is being received, the software program may also identify caller ID information regarding the incoming call, such as the incoming telephone number (e.g., (111) 111-1111) of the originating device and the telephone number to which the incoming call is being made (e.g., a DID telephone number associated with a receiving device), using any caller-ID mechanism.

The process 40 determines whether the incoming call should be challenged (at decision block 42). In particular, the software program 23 may determine the caller-ID information from the incoming call and perform a table lookup into the subscriber data 25 to determine whether the subscriber has authorized (or activated) the call screening feature. If so, the program determines whether the incoming call should be challenged based on the caller-ID information (e.g., a telephone number of the incoming call, etc.) and the subscriber data 25. In one embodiment, the program may make the determination based on the subscriber-specific data analytics. For example, the program may determine that the incoming call is to be challenged based on whether the subscriber has made an outgoing call to the same phone number associated with the incoming telephone number. More about how this determination is made is described in FIG. 5.

If the incoming call should not be challenged (e.g., the subscriber has made an outgoing call to the originating device's phone number), the software program 23 routes the incoming call to the receiving device (at block 43). For instance, the program may forward the incoming call to the receiving device, as described herein. If, however, it is determined that the incoming call should be challenged (e.g., based on the subscriber's analytics), the program answers the incoming call to establish a communication link with the originating device (at block 44). For instance, the program may instruct the communications interface (via an API) to establish the link. Once established, the server will begin receiving an incoming or so called downlink communications audio signal or call content signal or stream being transmitted by the originating device.

The process 40 transmits, via the communication link, a challenge audio signal (e.g., as an uplink signal) containing an audio message for playback by the originating device (at block 45). Specifically, the software program 23 may retrieve the challenge audio signal from local memory (e.g., the subscriber data 25), where the challenge audio signal may be associated with the subscriber. For instance, the software program may determine (e.g., through a table lookup) that a particular challenge audio signal is to be transmitted when an inbound call is received for a particular subscriber. For instance, as described herein, the program 23 may perform a table lookup into the subscriber data 25 to identify a challenge for the inbound caller. Specifically, the challenge may be for this particular inbound caller (as defined by the subscriber), or may be based on call analytics of the inbound caller.

The process 40 determines if a response has been received, via the communication link as a downlink signal, within a threshold period of time (at decision block 46). Specifically, once the challenge audio signal is transmitted, the program 23 may wait a period of time (e.g., eight seconds) in order to allow the inbound caller a moment to answer, either via a selection of keys on a keypad or via speech. If not, the process 40 transmits, via the communication link, a final message audio signal containing an audio message for playback by the originating device that indicates the call is to be disconnected (at block 47). For instance, the audio message may simply be “Good bye.” in order to inform the inbound caller that the server is about to disconnect the call. In another embodiment, the audio message may provide an explanation for the call being disconnected (e.g., “This call is being terminated because it is believed this is a robocall.”) The process 40 then disconnects (or hangs up) the answered call (at block 48).

Returning to decision block 46, if, however, the process 40 determines that the response is received within the threshold period of time, the process 40 determines whether the response is correct (at decision block 49). In particular, the program determines whether to connect the originating device with the receiving device based on the response. For instance, upon receiving the response, the program may authenticate the response by comparing the response with the predefined response stored that is associated with the audio message of the challenge. For instance, when the challenge is prompting the inbound caller to say a word or phrase, the response may be a verbal response, which is transmitted to the program as a response audio signal from the originating device. The response audio signal may contain a word or phrase as speech, which the program may perform voice-to-text algorithm upon to produce a textual representation of the word or phrase. This representation may be compared to a textual representation of the predefined response to determine whether both representations match one another. As another example, when the challenge is prompting the inbound caller to select (e.g., numbered) keys on a keypad, the received response may be an ordered set of DTMF tones. The program may authenticate this response by determining whether the response contains the ordered DTMF tones that were predefined by the subscriber and stored within the subscriber data. If either response matches their corresponding predefined response, the response is considered to be correct and therefore authenticated by the program 23. In one embodiment, a “match” may be such that both the response of the inbound caller and the predefined response match exactly. In another embodiment, a match may occur when the response is only different from the predefined response within a threshold (e.g., the response matches 90% of the predefined response). Upon being correct, the process 40 proceeds to route the incoming call to the receiving device (at block 43). Thus, in response to receiving an authenticated response form the originating device, via the communication link, the program routes the incoming call to the receiving device.

If, however, the response is not correct (e.g., the response is not exactly the same as the predefined response), the process determines if the challenge audio signal has been transmitted N times (at decision block 50). For instance, the program may account for the inbound caller not being prepared to hear the challenge after the incoming call is answered by the server (e.g., the server may transmit the challenge audio signal after a threshold period of time of answering the call, such as one second). The inbound caller may only hear the first part of the challenge, or may not understand the challenge the first time. As a result, the response provided by the inbound caller may not be correct. Thus, in one embodiment, the program may repeat the challenge one or more times (e.g., a second time) in order to give the inbound caller a second chance. If the challenge has not been transmitted N times (e.g., two times), the process 40 returns to block 45 to transmit the challenge audio signal again. If, however, the challenge audio signal has been transmitted N times, the process 40 proceeds to block 47 to transmit the final message audio signal.

Thus, the process 40 provides a method to screen unwanted calls, such as scam calls by using subscriber-defined challenges. In addition, the process 40 may also block computerized autodialers or robocalls, due to the nature of such calls. For instance, upon answering a robocall, the computerized autodialer monitors the call for speech of a recipient (e.g., “Hello? Who is this?”). Upon recognizing speech, the autodialer may connect the recipient to a live person (e.g., a fraudster). Process 40 may provide additional protection to the routing of such calls due to the operations performed by the autodialer. Specifically, the live person whom the autodialer connects the call to does not hear the initial speech of the recipient. Thus, when program 25 receives an incoming call that is a robocall, the recognized speech used by the autodialer is the challenge (e.g., “What is my favorite color.”) that is transmitted by the program 25. When the live person is subsequently connected, the person would not have heard the challenge. As a result, the live person may not be able to provide the correct response due to not being privy to the challenge, and therefore the program will disconnect the call.

Some embodiments perform variations of the process 40. For example, the specific operations of the process 40 may not be performed in the exact order shown and described. The specific operations may not be performed in one continuous series of operations, some operations may be omitted, and different specific operations may be performed in different embodiments. For instance, before the program 23 determines whether the incoming call should be challenged, the program may determine whether the incoming call is associated with an existing subscriber. For instance, upon identifying the incoming (or intended) telephone number, the program may perform a table lookup into the subscriber data 25 to determine whether the telephone number is a DID telephone number that is assigned to an existing subscriber. If not, the program may transmit an audio signal containing an audio message indicating that this number is not associated with a subscriber. If so, the program may proceed with the process 40.

In another variation, rather than (or in addition to) transmitting the challenge via the communication link, the program may transmit the challenge via one or more other methods. For instance, the program may transmit (via the communications interface 20, a push notification in the form of a message (e.g., SMS) that includes a textual representation of the challenge (e.g., “Please enter one, two, and three for authentication”). The inbound caller may then select the three digits on a keypad or say the digits aloud in order to authenticate the call. As another example, the message may be transmitted via other means, such as an email.

In another variation, the program 23 may inform the subscriber when an incoming call is disconnected at block 48. For instance, the program 23 may transmit a push notification to the subscriber's receiving device, indicating that an incoming call had been screened and provide at least some caller-ID information (e.g., incoming telephone number, the inbound caller's name, etc.). As another example, the push notification may indicate that the call has been missed.

In one embodiment, at least some of the operations described herein are operational operations that may or may not be performed. Specifically, blocks that are illustrated as having dashed or dotted boundaries may optionally be performed. For example, the operations performed at block 47 and block 50 may be optional. With respect to block 47, when not performed the program 23 may immediately disconnect the call upon determining that the response has not been received within he period of time. In the case of block 50, the program 23 may only give the inbound caller one chance to provide the correct response. In one embodiment, both of these operations may be user-defined during set up of the voice call screening service, as described in FIG. 3.

FIG. 5 is a flowchart of one embodiment of a process 60 to determine whether an incoming call should be challenged, according to some embodiments. Specifically, the process 60 is determining whether the inbound caller is to be challenged by transmitting the challenge, as described herein, to the originating device and determining whether a received response matches a predefined response to the challenge. In one embodiment, at least some of the operations may be performed by the (telephony software program 23 of the telephony server 7 of the) telephony system 10, as described in FIGS. 1-2. In one embodiment, at least some of the operations of process 60 may be performed while the program 23 determines whether the incoming call should be challenged, at decision block 42 of FIG. 4.

The process 60 begins by determining, from the incoming call, caller ID (e.g., an incoming telephone number, a name of the inbound caller, etc.) associated with the originating device (at block 61). For instance, as described herein, the caller ID information may be a part of the incoming call. The process 60 determines whether the voice call screening service is enabled (at decision block 62). For instance, the program may perform a table lookup into the subscriber data using the telephone number that the originating device is calling (e.g., the receiving device's DID telephone number) to determine whether the subscriber has enabled the feature. If not, the process does not challenge the incoming call (at block 63). In one embodiment, by not challenging the incoming call, the program may automatically route the incoming call to the receiving device, as described herein.

If, however, the service is enabled, the process 60 determines if the subscriber of the receiving device specifically indicated that the inbound caller of the originating device is to be challenged (at decision block 64). In particular, the program may make this determination based on the subscriber data. For instance, the program determines whether the subscriber indicated (e.g., after creating the challenge and the response to the challenge, as described in FIG. 3) that the inbound caller is to be challenged. As another example, the determination may be based on whether the incoming phone number is contained within the subscriber's contact list, as described here. In particular, if the telephone number associated with the originating device is not contained within the contacts list of the subscriber's receiving device, the inbound caller may be challenged. In one embodiment, the subscriber may have indicated that the inbound caller to be challenged based on the caller's characteristics (e.g., the name of the caller, the phone number associated with the originating device, etc.). In another embodiment, the indication may be based on general characteristics, such as being based on an area code with which the incoming phone number belongs. If so, the process 60 challenges the incoming call (at block 65). For instance, the process 60 may proceed to block 44 in process 40 of FIG. 4.

If, however, the subscriber did not specifically indicate that the originating device to be challenged, the process 60 may use call analytics to determine whether the inbound caller is to be challenged. For instance, the process 60 determines whether the receiving devices has made an outgoing call to the originating device within a (first) past period of time (e.g., ninety days) (at decision block 66). Specifically, the program is determining whether the subscriber has initiated a phone call with the inbound caller within a recent period of time. If so, the process 60 does not challenge the originating device. If, however, the receiving device has not made an outgoing call to the originating device, the process 60 determines if the subscriber has picked up a previous incoming call from the originating device within a (second) past period of time (at decision block 67). In one embodiment, the first and second past periods of time may be the same or different. In another embodiment, the program may also determine whether the subscriber has remained on the line for a period of time (e.g., thirty seconds). For instance, if the call is a scam call, the subscriber may hang up relatively quickly, as opposed to a business or personal phone call. Thus, if the subscriber has picked up, the process may not challenge the incoming call. If, however, the subscriber has not picked up, the process 60 may challenge.

Some embodiments perform variations of the process 60. For example, the specific operations of the process 60 may not be performed in the exact order shown and described. The specific operations may not be performed in one continuous series of operations, some operations may be omitted, and different specific operations may be performed in different embodiments. For instance, the process 60 may make the determination of whether to challenge or not based on additional call analytics, such as the duration of answered calls and the frequency at which calls are picked up by the subscriber. For instance, if incoming calls from the inbound caller are picked up with a high frequency (e.g., once a day), the call may not be challenged. If, however, the inbound caller calls several times in one day, without the subscriber pickup up, the incoming call may be challenged. In one embodiment, at least some incoming calls will not be challenged based on certain criteria. Specifically, the program 23 may not challenge some incoming calls, regardless of whether the incoming calls meet the criteria to be challenged, as described herein. For instance, the program 23 may allow incoming calls associated with public services and emergency services to not be challenged. As another example, incoming calls associated with emergency contacts (e.g., within the subscriber's contacts list), may not be challenged.

In one embodiment, any of the periods of time described herein may be user-configurable. For example, the threshold period of time the program waits to receive a response at block 46 may be user-configurable to be longer or shorter than describe herein (e.g., being ten seconds rather than eight seconds).

An embodiment may be an article of manufacture in which a non-transitory machine-readable storage medium has stored thereon instructions which program one or more data processing components (generically referred to here as “a processor”) to perform the operations described above. For example, in one embodiment, the above-described processes (e.g., processes 30, 40, and 60 of FIG. 3, FIG. 4, and FIG. 5, respectively) may be performed by the processor 21 that is executing instructions stored in the non-transitory machine-readable storage medium. The non-transitory machine readable storage medium may be a part of the telephony server 7, as described herein. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad disclosure, and that the disclosure is not limited to the specific constructions and arrangements shown and described, since various other modifications may occur to those of ordinary skill in the art.

In some embodiments, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some embodiments, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method comprising:
receiving, from an originating device, an incoming call to be routed to a receiving device;
answering the incoming call to establish a communication link with the originating device;
transmitting, via the communication link, a challenge audio signal containing an audio message for playback by the originating device;
receiving, via the communication link, a response from the originating device; and
in response to authenticating the response, routing the incoming call to the receiving device.

2. The method of claim 1 further comprising
determining, from the incoming call, a telephone number associated with the originating device; and
determining that the incoming call should be challenged based on the telephone number.

3. The method of claim 2, wherein answering the incoming call and transmitting the challenge audio signal are in response to determining that the incoming call should be challenged.

4. The method of claim 2, wherein determining that the incoming call should be challenged comprises determining that the receiving device has not either made an outgoing call to the originating device or picked up a previous incoming call from the originating device within a past period of time.

5. The method of claim 2, wherein determining that the incoming call should be challenged comprises determining that the telephone number associated with the originating device is not contained within a contacts list of the receiving device.

6. The method of claim 1 further comprising authenticating the response by comparing the response with a predefined response that is associated with the audio message.

7. The method of claim 6, wherein the predefined response is an ordered plurality of Dual-Tone Multi-Frequency (DTMF) tones, wherein authenticating comprises determining that the response contains the ordered plurality of DTMF tones.

8. The method of claim 6, wherein the predefined response is text of a word or a phrase, wherein the response is a response audio signal that contains a word or phrase as speech, wherein authenticating comprises performing a speech-to-text algorithm upon the response audio signal to produce a textual representation of the word or phrase and determining that the textual representation matches the text.

9. The method of claim 6 further comprising, prior to receiving the incoming call, receiving and storing the audio message and the predefined response.

10. A non-transitory machine-readable medium having stored therein instructions which when executed by at least one processor:
receive, from an originating device, an incoming call to be routed to a receiving device;
answer the incoming call;
transmit, as an uplink signal, a challenge audio signal containing an audio message to be played back by the originating device;
receive, as a downlink signal, a response from the originating device;
determining whether to connect the originating device with the receiving device based on the response;
in response to determining to connect both devices, route the incoming call to the receiving device; and
in response to determining not to connect both devices, disconnect the answered call.

11. The non-transitory machine-readable medium of claim 10 has further instructions to
determine, from the incoming call, a telephone number associated with the originating device; and
determine that the incoming call should be challenged based on the telephone number.

12. The non-transitory machine-readable medium of claim 11, wherein the instructions to answer and transmit are in response to determining that the incoming call should be challenged.

13. The non-transitory machine-readable medium of claim 11, wherein the instructions to determine that the incoming call should be challenged comprises instructions to determine that the receiving device has not either made an outgoing call to the originating device or picked up a previous incoming call from the originating device within a past period of time.

14. The non-transitory machine-readable medium of claim 11, wherein the instructions to determine that the incoming call should be challenged comprises instructions to determine that the telephone number associated with the originating device is not contained within a contacts list of the receiving device.

15. The non-transitory machine-readable medium of claim 10 has further instructions to authenticate the response by comparing the response with a predefined response that is associated with the audio message.

16. The non-transitory machine-readable medium of claim 15, wherein the predefined response is an ordered plurality of Dual-Tone Multi-Frequency (DTMF) tones, wherein the instructions to authenticate comprises instructions to determine that the response contains the ordered plurality of DTMF tones.

17. The non-transitory machine-readable medium of claim 15, wherein the predefined response is text of a word or a phrase, wherein the response is a response audio signal that contains a word or phrase as speech, wherein the instructions to authenticate comprises instructions to perform a speech-to-text algorithm upon the response audio signal to produce a textural representation of the word or phrase and to determine that the textual representation matches the text.

18. The non-transitory machine-readable medium of claim 15 further has instructions to, prior to receiving the incoming call, receive and store the audio message and the predefined response.

19. A telephony server comprising
a processor; and
non-transitory machine-readable medium having stored therein instructions which when executed by the processor cause the telephony server to
receive, from an originating device, an incoming call to be routed to a receiving device;
answer the incoming call to establish a communication link with the originating device;
transmit, via the communication link, a challenge audio signal containing an audio message for playback by the originating device;
in response to receiving an authentic response from the originating device, via the communication link, routing the incoming call to the receiving device.

20. The telephony server of claim 19, wherein the non-transitory machine-readable medium has further instructions to
determine whether a response is received, via the communication link, from the originating device within a threshold period of time; and
in response to not receiving the response within the threshold period of time,
transmitting a final message audio signal, via the communication link, containing an audio message for playback by the originating device that indicates the call is to be disconnected; and
disconnecting the call.

21. The telephony server of claim 19, wherein the non-transitory machine-readable medium has further instructions to
determine, from the incoming call, a telephone number associated with the originating device; and
determine that the incoming call should be challenged based on the telephone number.

22. The telephony server of claim 21, wherein the instructions to answer the incoming call and transmit the challenge audio signal are in response to determining that the incoming call should be challenged.

23. The telephony server of claim 21, wherein the instructions to determine that the incoming call should be challenged comprises instructions to determine that the receiving device has not either made an outgoing call to the originating device or picked up a previous incoming call from the originating device within a past period of time.

24. The telephony server of claim 21, wherein the instructions to determine that the incoming call should be challenged comprises instructions to determine that the telephone number associated with the originating device is not contained within a contacts list of the receiving device.

25. The telephony server of claim 19, wherein the non-transitory machine-readable medium has further instructions to
receive a response, via the communication link, from the originating device; and
determine that the response is an authentic response by comparing the response with a predefined response that is associated with the audio message.

26. The telephony server of claim 25, wherein the predefined response is an ordered plurality of Dual-Tone Multi-Frequency (DTMF) tones, wherein the instructions to authenticate comprises instructions to determine that the response contains the ordered plurality of DTMF tones.

27. The telephony server of claim 25, wherein the predefined response is text of a word or a phrase, wherein the response is a response audio signal that contains a word or phrase as speech, wherein the instructions to authenticate comprises instructions to perform a speech-to-text algorithm upon the response audio signal to produce a textual representation of the word or phrase and to determine that the textual representation matches the text.

28. The telephony server of claim 25, wherein the non-transitory machine-readable medium has further instructions to, prior to receiving the incoming call, receive and store the audio message and the predefined response.
